(19) United States
(12) Patent Application Publication
(10) Pub. No.: US 2009/0261067 A1
(43) Pub. Date: Oct. 22, 2009

(54) METHODS AND APPARATUS FOR PROTOTYPING THREE DIMENSIONAL OBJECTS FROM A PLURALITY OF LAYERS

(76) Inventor: Robert Alan Dietrich, Montebello, CA (US)

Correspondence Address: Robert A. Dietrich, 1648 Via Palermo, Montebello, CA, 90640, US

(21) Appl. No.: 12/107,750

(22) Filed: Apr. 22, 2008

(51) Int. Cl. B44C 1/22

(52) U.S. Cl. 216/83

(57) ABSTRACT

The present invention is directed to methods and apparatus for prototyping three dimensional objects from a plurality of sequential layers that satisfies the need for an inexpensive method for producing both appearance models and functional parts. The method of the present invention includes building cross sectional portions of a three dimensional article, and assembling the individual cross sectional areas in a layer wise fashion to form a final article. The individual cross sectional areas are built by using an ink jet print head to deliver an aqueous solvent to cut the construction material to be adhered to previous cross sectional areas

### BACKGROUND OF THE INVENTION

This invention relates generally to rapid prototyping techniques, and more particularly to a three dimensional prototyping method using an ink jet printer to chemically cut paper that is stacked and adhered.

The field of rapid prototyping involves the production of prototype articles and small quantities of functional parts. Many methods are used to create these parts. These methods include Stereolithography, Selective Laser Sintering, Fused Deposition Modeling, and Laminated Object Manufacturing. The current method of Laminated Object Manufacturing is to cut the construction material with a laser, or machine head, then apply adhesive and stack the layers. The drawbacks of all of the rapid prototyping methods are that they require a specifically designed machine to produce the prototype articles. These machines are expensive.

Relevant prior art include U.S. Pat. Nos. 5,663,883, 5,876,550, 5,902,441, 6,324,438

### BRIEF SUMMARY OF THE INVENTION

It is an object of the present invention to provide methods and apparatus for prototyping three dimensional objects that are inexpensive to implement compared with conventional rapid prototyping systems and methods.

It is another object of the present invention to provide methods and apparatus for prototyping three dimensional objects that can produce parts from inexpensive raw materials.

These and other objects of the present invention are provided by methods and apparatus for prototyping three dimensional objects from a plurality of layers wherein each layer is chemically cut with an ink jet print head and fused with the preceding layer.

The advantage of using an ink jet print head is that a standard ink jet printer can be fitted with a specific ink jet print head to deliver the solvent to cut paper that is used as construction material. This is much less expensive than a machine manufactured in small quantities that uses a laser or machine head for cutting. For more precise control of the cutting process the ink-jet print head can use multiple solvents in separate reservoirs that will be applied to the same position on the paper. These solvents when used individually either do not cut the paper or cut the paper very slowly. Only when combined do they react to make a precise cut. Additionally another reservoir can be used for a stop solution. This stop solution would be applied to the paper in the areas adjacent to the cut areas to halt the solvent from spreading. For ease of adhering and stacking the paper, another print head reservoir can be used to apply adhesive to specific areas of the paper.

Pretreated paper can also be use to aid in the process of cutting or adhering. This would allow the solvent or the adhesive to be specifically formulated to the pretreated paper. As the paper is ejected from the printer, the paper can be stacked without the need to apply adhesive as a separate process. A complex three-dimensional shape can be accurately constructed by designing the object with support spars. These support spars will not allow the object to be released from the original paper. The sheets of paper can then be stacked and bonded in a standard box. After the adhesive has cured the support spars can be cut away, releasing the three-dimensional object.

The methods and apparatus of the present invention offer the advantage of being able to fabricate relatively complex shapes inexpensively compared to all other conventional rapid prototyping methods. The present invention is more economical than prior art methods because both the equipment and the materials used are inexpensive.

These and other features, aspects and advantages of the present invention will become better understood with reference to the following description and claims.

### BRIEF DESCRIPTION OF THE SEVERAL VIEWS OF THE DRAWING

FIG. 1 illustrates an ink-jet nozzle delivering a fluid to a portion of the construction material.

FIG. 2 illustrates a view of the final article made from a series of steps illustrated in FIG. 1.

FIG. 3 illustrates a view of the final article made from a series of steps illustrated in FIG. 1 with support spars.

FIG. 4 illustrates a view of the final assembled article made from a series of steps illustrated in FIG. 3 being stacked and bonded.

FIG. 5 illustrates a view of the final assembled article made from a series of steps illustrated in FIG. 2 being stacked and bonded or the final assembled article made from a series of steps illustrated in FIG. 4 having the support spars removed.

### DETAILED DESCRIPTION OF THE INVENTION

The present invention relates to methods and apparatus for prototyping three dimensional objects comprising a printer with an ink jet print head containing a solvent or solvents, and can also contain an adhesive, that are applied to a layer of construction material.

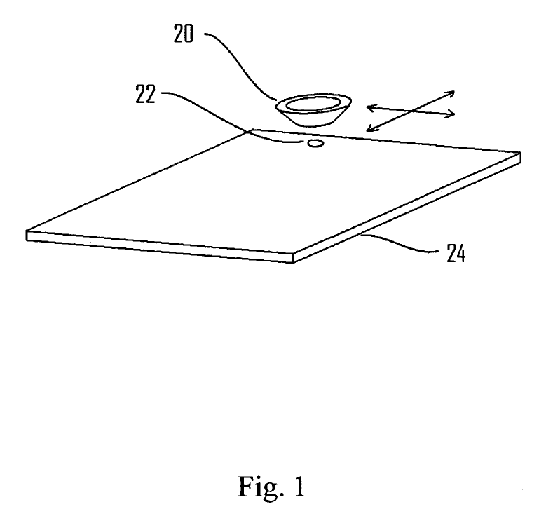

Referring to FIG. 1, a schematic representation of an ink jet print head nozzle 20 delivering solvent 22 to a portion of a layer of construction material 24. According to the method, the solvent 22 is delivered to the layer of construction material 24 as the printer moves the print head nozzle 20. The construction material 24 will be cut by the solvent 22. The application of the solvent 22 is controlled by a computer in a similar manner to the application of ink in a standard ink jet printer. A separate reservoir in the same print head can contain a stop solution. This stop solution can be used to more accurately control the cut areas. Using a reservoir containing adhesive the same ink jet print head can be used to apply the adhesive. The solvent, stop solution and adhesive can be applied during the same pass across the construction material.

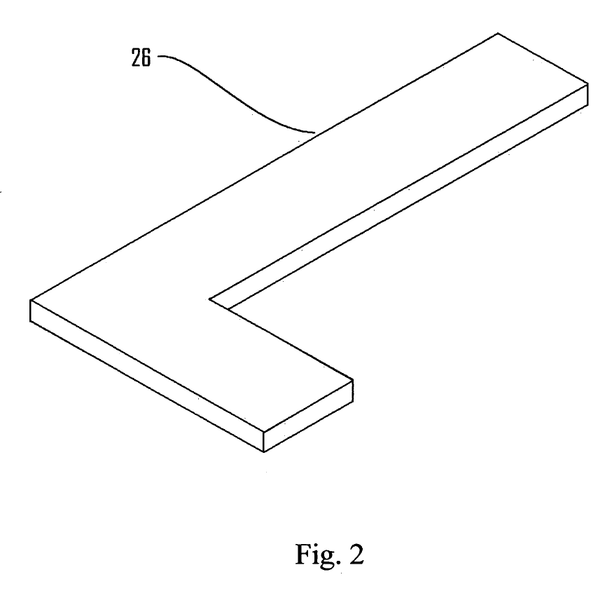

Referring to FIG. 2, a schematic representation of a layer of construction material with the waste construction material discarded leaving the finished layer 26. These layers can have multiple features cut into the same layer. Holes can be cut by the solvent to be used to align the layers with pins or dowels to keep the layers properly oriented during bonding.

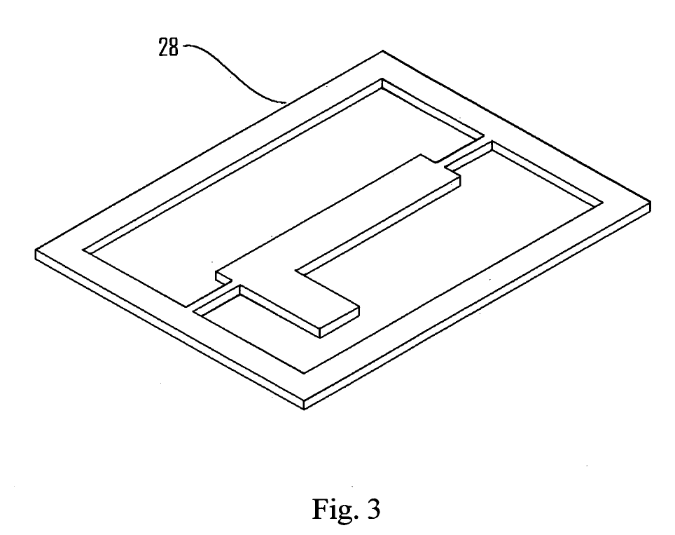

Referring to FIG. 3, a schematic representation of a layer of construction material with the waste construction material discarded leaving the finished layer 28 showing support spars and outer edges of the construction material.

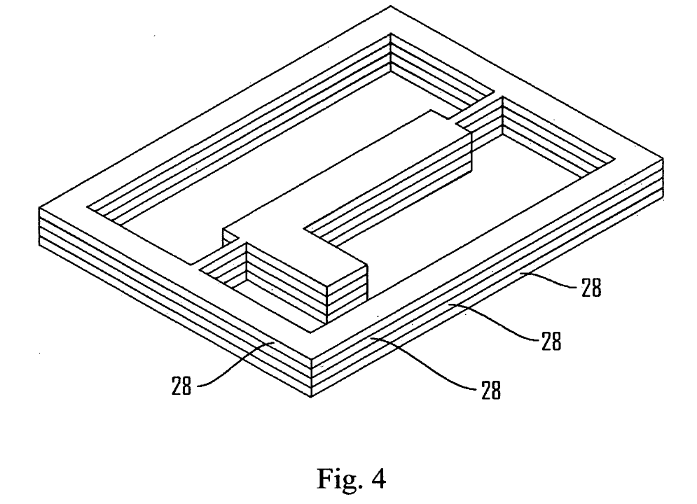

Referring to FIG. 4, a schematic representation of multiple layers of the finished construction material layer 28 being stacked and bonded. These layers can easily be aligned in a box or fixture sized to accommodate the original shape of the construction material.

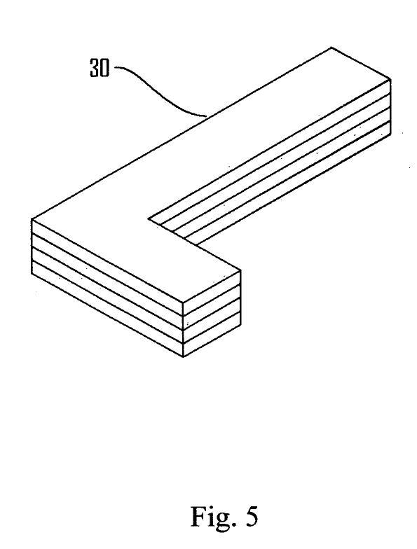

Referring to FIG. 5, a schematic representation of the finished three dimensional object 30 having been constructed from multiple layers of construction material. This could have been made from a number of oriented, stacked, and bonded finished layers 26. This also could have been made from a number of oriented, stacked and bonded finished layers 28 having the support spars manually removed. The finished three dimensional object 30 will be essentially the same.

It should be understood that the foregoing relates to exemplary embodiments of the invention and that modifications may be made without departing from the spirit and scope of the invention as set forth in the following claims.

What I claim as my invention is:

1. A method of converting layers of sheet material into a plurality of slices that form a three-dimensional object comprising forming a stack of sheet material by positioning said layer of said sheet material and by cutting said sheet material by an aqueous solvent delivered by an ink jet print head.

2. The method of claim 1, involving cutting said sheet material by multiple aqueous solvents delivered by said ink jet print head.

3. The method of claim 1, involving limiting the cut area of said sheet material by an aqueous stop solution delivered by said ink jet print head.

4. The method of claim 1, involving applying an aqueous adhesive to said sheet material by said ink jet print head.

5. The method of claim 2, involving limiting the cut area of said sheet material by an aqueous stop solution delivered by said ink jet print head.

6. The method of claim 2, involving applying an aqueous adhesive to said sheet material by said ink jet print head.

7. The method of claim 3, involving applying an aqueous adhesive to said sheet material by said ink jet print head.

8. The method of claim 5, involving applying an aqueous adhesive to said sheet material by said ink jet print head.

9. The method of claim 1, involving using chemically pretreated sheet material.

10. The method of claim 2, involving using chemically pretreated sheet material.

11. The method of claim 3, involving using chemically pretreated sheet material.

12. The method of claim 4, involving using chemically pretreated sheet material.

13. The method of claim 5, involving using chemically pretreated sheet material.

14. The method of claim 6, involving using chemically pretreated sheet material.

15. The method of claim 7, involving using chemically pretreated sheet material.

16. The method of claim 8, involving using chemically pretreated sheet material.
